(19) United States
(12) Patent Application Publication
(10) Pub. No.: US 2018/0174541 A1
(43) Pub. Date: Jun. 21, 2018

(54) DISPLAY DEVICE AND IMAGE CONTROL METHOD FOR DISPLAY DEVICE

(71) Applicant: SHARP KABUSHIKI KAISHA, Sakai City, Osaka (JP)

(72) Inventor: MASAYUKI TAKAHASHI, Sakai City (JP)

(21) Appl. No.: 15/577,186

(22) PCT Filed: Apr. 20, 2016
(86) PCT No.: PCT/JP2016/062498

§ 371 Date: Nov. 27, 2017

(30) Foreign Application Priority Data
May 28, 2015 (JP) 2015-109032

(51) Int. Cl. G09G 3/36; G02F 1/01

(52) U.S. Cl. CPC G09G 3/3677; G02F 1/0105

(57) ABSTRACT

The present invention controls images displayed on a high-definition panel without damaging gate drivers and related components. The liquid crystal display panel (10) includes: gate lines (41 to 44) provided independently for each area; and gate drivers (31A to 34A and 31B to 34B) provided independently for each area. Each TCON (21 to 24) supplies a drive signal to drive associated gate drivers (31A to 34A and 31B to 34B) based on an externally supplied video signal.

### TECHNICAL FIELD

The present invention relates to display devices and image control methods for display devices.

### BACKGROUND ART

Display devices are known that include a plurality of timing controllers to drive a high-definition display panel.

FIG. 13 is a block diagram of a conventional display device including two timing controllers.

In the conventional display device shown in FIG. 13, each timing controller (TCON) 321 and 322 supplies a gate-driver-driving signal GDsig to gate drivers and a source-driver-driving signal SDsig to source drivers.

To display an image on a display panel 310 in the conventional display device configured in this manner, the TCONs 321 and 322 need to be synchronized by designating one of these two timing controllers (e.g., TCON 321) as the master and the other (e.g., TCON 322) as a slave.

Patent Literature 1 describes a liquid crystal display device including: a plurality of liquid crystal display panels arranged in a single direction; gate drivers, one for each liquid crystal display panel, for selecting from gate lines; source drivers, one for each liquid crystal display panel, for setting the electric potentials of source lines; and a TCON. In the liquid crystal display device of Patent Literature 1, the single TCON controls all the gate and source drivers for the liquid crystal display panels.

The provision of one TCON in this manner allows for cost reduction and synchronization in each combination of a liquid crystal display panel, gate drivers, and source drivers.

### CITATION LIST

### Patent Literature

Patent Literature 1: Japanese Unexamined Patent Application Publication, Tokukai, No. 2012-237868A (Publication Date: Dec. 6, 2012)

### SUMMARY OF INVENTION

### Technical Problem

A single TCON however has limits on the frame rate and addressable pixel count and falls short of driving 8K and other large-sized, super-high-definition panels, which is the case with the liquid crystal display device of Patent Literature 1.

A plurality of TCONs is needed to drive pixels in 8 K and other large-sized, super-high-definition panels.

FIG. 14 is a block diagram of a conventional 8 K display device including four timing controllers.

An 8 K or other large-sized, super-high-definition liquid crystal panel is required to handle 16 to 32 times as much information as a high-vision display panel. To fulfill this requirement, at least 4 times as many TCON substrates as in a high-vision display device are needed. The large-sized, super-high-definition liquid crystal panel also needs to handle at least 16 times as many signals. These specifications make it unrealistic to provide all the TCONs on a single substrate.

Accordingly, the display device shown in FIG. 14 uses four TCON substrates that, each capable of 4K resolution, carry thereon TCONs 421, 422, 423, and 424 that control driving of display areas 411, 412, 413, and 414 of a display panel 410 to produce an 8 K display.

In the display device shown in FIG. 14, gate drivers, which drive the gates of the display panel 410, are provided on both the left and right edges of the display panel 410 such that the ends of each gate line are connected to these left and right gate drivers, to increase driving capability.

If the TCONs go out of synchronization in this configuration of display device, the left and right drivers drive the gate lines and CS lines (retention capacitor lines) at different timings.

If a gate line is driven at different timings by the left and right drivers, an end of the gate line is at high voltage level, and the other end is at low voltage level. This voltage difference will generate a current flow through the gate driver, potentially damaging the gate driver and TCON.

The present invention, conceived in view of this issue, has an object to provide a display device, as well as a method of controlling an image on a display device, that is capable of controlling images displayed on a high-definition panel without damaging gate drivers and related components.

### Solution to Problem

To address the issue, the present invention, in an aspect thereof, is directed to a display device including: a display panel including an array of pixels; and a plurality of control units, one for each one of areas of a display surface of the display panel, configured to control images displayed in the areas, wherein the display panel includes: gate lines provided independently for each area; and gate drivers provided independently for each area and applying a voltage to the gate lines to sequentially scan the pixels, and each control unit supplies a drive signal to drive an associated one(s) of the gate drivers based on an externally supplied video signal.

To address the same issue, the present invention, in an aspect thereof, is directed to a method of controlling an image on a display device including: a display panel including an array of pixels; and gate lines provided independently for each one of areas of a display surface of the display panel, the method including the step of applying a voltage to the gate lines separately for each area based on an externally supplied video signal.

### Advantageous Effects of Invention

The present invention, in an aspect thereof, provides a display device, as well as a method of controlling an image on a display device, that is capable of controlling images displayed on a high-definition panel without damaging gate drivers and related components.

### BRIEF DESCRIPTION OF DRAWINGS

FIG. 1 is a detailed schematic view of a liquid crystal display device in accordance with Embodiment 1 of the present invention.

FIG. 2 is a schematic diagram illustrating a correspondence between areas and timing controllers of a liquid crystal panel in the liquid crystal display device in accordance with Embodiment 1 of the present invention.

FIG. 3 is a schematic view of the liquid crystal display device in accordance with Embodiment 1 of the present invention.

FIG. 4 is a schematic view of a liquid crystal display device in accordance with a variation example of Embodiment 1 of the present invention.

FIG. 5 is a drawing showing example images displayed on a liquid crystal display panel in the liquid crystal display device in accordance with the variation example of Embodiment 1 of the present invention.

FIG. 6 is a schematic view of a liquid crystal display device in accordance with Embodiment 2 of the present invention.

FIG. 7 is a detailed schematic view of the liquid crystal display device in accordance with Embodiment 2 of the present invention.

FIG. 8 is a drawing showing example images displayed on a liquid crystal display panel in the liquid crystal display device in accordance with Embodiment 2 of the present invention.

FIG. 9 is a schematic view of a liquid crystal display device in accordance with Embodiment 3 of the present invention.

FIG. 10 is a detailed schematic view of the liquid crystal display device in accordance with Embodiment 3 of the present invention.

Portion (a) of FIG. 11 is a drawing showing an example image displayed on a liquid crystal display panel in the liquid crystal display device in accordance with Embodiment 3 of the present invention, and portion (b) of FIG. 11 is a drawing showing another example use of the liquid crystal display panel in the liquid crystal display device in accordance with Embodiment 3 of the present invention.

FIG. 12 is a detailed schematic view of a liquid crystal display device in accordance with a variation example of the present invention.

FIG. 13 is a block diagram of a conventional display device including two timing controllers.

FIG. 14 is a block diagram of a conventional 8 K display device including four timing controllers.

### DESCRIPTION OF EMBODIMENTS

### Embodiment 1

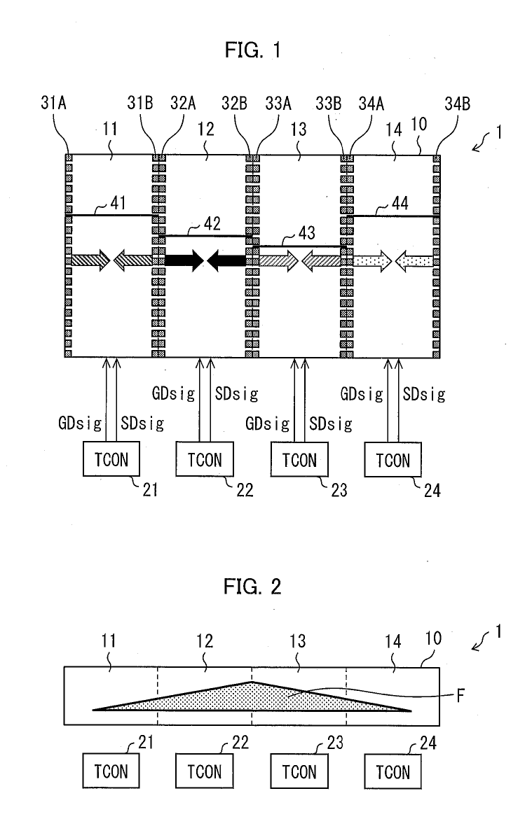

The following will describe in detail an embodiment of the present invention in reference to FIGS. 1 to 5. Although the following will describe a liquid crystal display device as an example of the display device in accordance with the present invention, the present invention is by no means limited to this example and applicable to OLEDs and other like display devices. The present invention is further applicable to horizontal screens and digital signage devices.

### Liquid Crystal Display Device

FIG. 2 is a schematic diagram illustrating a correspondence between areas and timing controllers of a liquid crystal panel in a liquid crystal display device in accordance with the present embodiment.

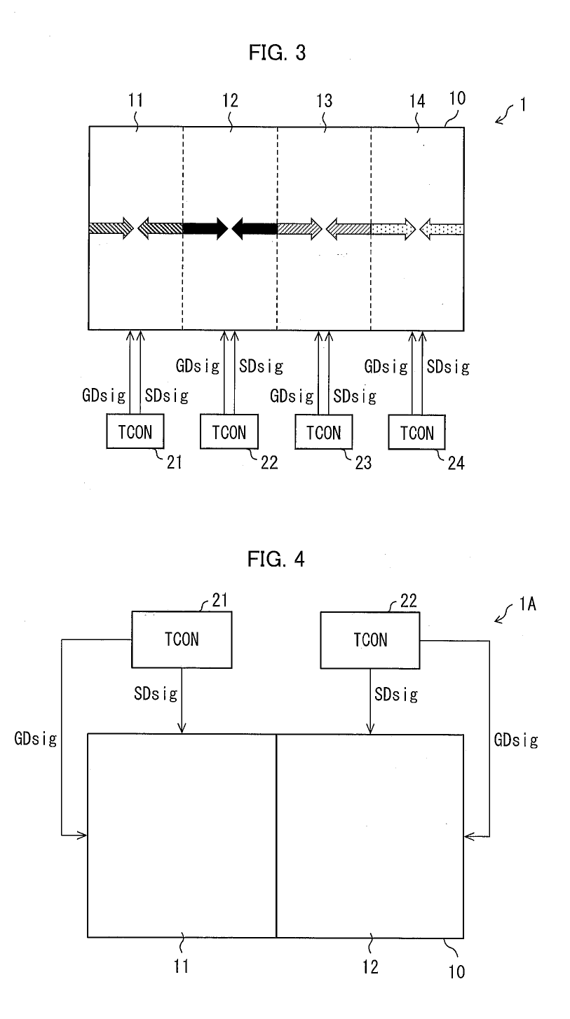

FIG. 3 is a schematic view of the liquid crystal display device in accordance with the present embodiment.

As shown in FIG. 2, a liquid crystal display device 1 (display device) in accordance with the present embodiment includes a liquid crystal display panel 10 (display panel), a backlight. (not. shown), gate drivers (not shown), source drivers (not shown), and four timing controllers 21, 22, 23, 24 (control units).

The liquid crystal display panel 10 includes a plurality of pixels that emit light of different colors, i.e., red pixels, green pixels, and blue pixels (not shown). The liquid crystal display panel 10 is an “8 K super-high-vision” liquid crystal display panel with a matrix of 7,680 pixels by 4,320 pixels (aspect ratio of 16:9).

The liquid crystal display panel 10 is provided with source lines (not shown) for respective columns of pixels and gate lines (not shown) for respective rows of pixels.

In the active matrix driving scheme where each pixel has a TFT (thin film transistor), each source line is connected to the source terminals of associated TFTs, whereas each gate line is connected to the gate terminals of associated TFTs. The drain terminal of each TFT is connected to a pixel electrode that is one of electrodes sandwiching a liquid crystal layer.

Referring to FIG. 3, the timing controllers (hereinafter, “TCONs”) generate various control signals, such as gate driver control signals GDsig, source driver control signals SDsig, and clock signals, for controlling the operation of the gate and source drivers based on externally supplied video signals, and supply the generated control signals to the gate and source drivers.

The gate drivers apply a voltage to the gate lines one by one based on the gate driver control signals GDsig (drive signals) fed from the TCONs 21, 22, 23, and 24, to sequentially scan the rows of pixels.

The source drivers generate data signals of a predetermined voltage to be fed to the pixel electrodes of the pixels based on the source driver control signals SDsig fed from the TCONs 21, 22, 23, and 24, and supply the generated data signals to the source lines.

By applying a voltage to the gate lines sequentially, the rows of pixels are selected a row at a time. When the data signals are fed to the source lines, the optical transmittance of the liquid crystal layer in the selected pixels connected to those source lines changes in accordance with the data signals. The light that is transmitted through the liquid crystal layer in accordance with the optical transmittance of the liquid crystal layer then shines on RGB color filters, so that red pixels emit red light, green pixels emit green light, and blue pixels emit blue light. A full-color image is hence displayed on a display surface of the liquid crystal display panel 10 by the light emitted by the pixels.

Referring to FIG. 2, the display surface of the liquid crystal display panel 10 is divided into four rectangular areas that are arranged side by side. The TCONs 21, 22, 23, and 24 are associated respectively with these areas to control the images displayed in the areas.

Specifically, the display surface of the liquid crystal display panel 10 is divided into a first area 11, a second area 12, a third area 13, and a fourth area 14. The TCON 21 is associated with the first area 11, the TCON 22 is associated with the second area 12, the ICON 23 is associated with the third area 13, and the TCON 24 is associated with the fourth area 14.

Each of the areas 11, 3, and 14, into which the display surface is divided, is a display area with 1,920×4,320 pixels.

In the liquid crystal display device 1, the four TCONs 21, 22, 23, and 24 are used to independently control driving of the pixels in the areas 11, 12, 13, and 14. The TCONs 21, 22, 23, and 24, each capable of 4 K resolution, drive 1,920×4,320 pixels in a controlled manner at 120 Hz.

This configuration allows for an increased maximum pixel count and an increased maximum frame rate for the liquid crystal display panel 10, thereby producing a super-high-vision (7,680 pixels by 4,320 pixels, 120 Hz) image F as shown in FIG. 2.

### Gate Drivers and Gate Lines

FIG. 1 is a detailed schematic view of the liquid crystal display device in accordance with the present embodiment.

As shown in FIG. 1, a pair of gate drivers is monolithically formed in each area of the liquid crystal display panel 10.

Specifically, the areas are all rectangular. A pair of gate drivers 31A and 31B is provided on the opposing longer edges of the first area 11. A pair of gate drivers 32A and 32B is provided on the opposing longer edges of the second area 12. A pair of gate drivers 33A and 33B is provided on the opposing longer edges of the third area 13. A pair of gate drivers 34A and 34B is provided on the opposing longer edges of the fourth area 14.

The TCON 21 supplies a gate-driver-driving signal GDsig to the gate drivers 31A and 31B for the first area 11 and a source-driver-driving signal SDsig to source drivers. The TCON 22 supplies a gate-driver-driving signal GDsig to the gate drivers 32A and 32B for the second area 12 and a source-driver-driving signal SDsig to source drivers. The TCON 23 supplies a gate-driver-driving signal GDsig to the gate drivers 33A and 33B for the third area 13 and a source-driver-driving signal SDsig to source drivers. The TCON 24 supplies a gate-driver-driving signal GDsig to the gate drivers 34A and 34B for the fourth area 14 and a source-driver-driving signal SDsig to source drivers.

The first area 11 is provided with a group of gate lines 41. The second area 12 is provided with a group of gate lines 42. The third area 13 is provided with a group of gate lines 43. The fourth area 14 is provided with a group of gate lines 44. Each group of gate lines is provided for an associated one of the areas, independently from the other groups.

The gate drivers 31A and 31B apply a voltage to the ends of each gate line 41 in the first area 11. The gate drivers 32A and 32B apply a voltage to the ends of each gate line 42 in the second area 12. The gate drivers 33A and 33B apply a voltage to the ends of each gate line 43 in the third area 13. The gate drivers 34A and 34B apply a voltage to the ends of each gate line 44 in the fourth area 14.

This configuration enables individual control of the images displayed in the areas based on video signals fed to the TCONs 21, 22, 23, and 24, thereby producing an 8 K super-high-vision or like high-definition image on the liquid crystal display panel 10.

The TCONs control the images displayed in the areas individually. The group of gate lines for each area is independent from those groups for the other areas, such that the gate drivers for each area can apply a voltage to the gate lines in that area based on the gate-driver-driving signal GDsig supplied from the TCON associated with the area. Each pair of gate drivers therefore applies a voltage to the ends of each gate line in the associated area at the same timing without having to synchronize the gate-driver-driving signals GDsig supplied. by the TCONs 21, 22, 23, and 24. No excessive current hence flows through the gate lines, which enables control of display images without damaging the gate drivers and related components.

If the video signals fed from external video signal sources to the TCONs 21, 22, 23, and 24 are not synchronized, the image control method for the liquid crystal display device 1 in accordance with the present embodiment is still capable of displaying independent images in the areas based on those video signals because each TCON 21, 22, 23, and 24 supplies a gate-driver-driving signal GDsig based on its own one of the video signals.

The liquid crystal display device 1 in accordance with the present embodiment includes monolithically formed gate drivers, which do not need to be mounted to the liquid crystal display panel, as in the typical conventional liquid crystal display device, This configuration hence reduces the manufacturing cost of the liquid crystal display device 1 and the frame width of the liquid crystal display panel.

In addition, the TCONs 21, 22, 23, and 24 do not need to be synchronized, which obviates the need for those wires (e.g., connectors and cables) which would otherwise be provided for synchronizing purposes.

The crystal display panel 10 has so far been described as an 8 K super-high-vision liquid crystal display panel with a matrix of 7,680 pixels by 4,320 pixels (aspect ratio of 16:9). The liquid crystal display panel 10 is by no means limited to these pixel count and aspect ratio. The present invention is suitably applicable to large-sized, super-high-definition liquid crystal display devices including the liquid crystal display panel 10 with 4 K×2 K or more pixels.

### Variation Example

FIG. 4 is a schematic view of a liquid crystal display device in accordance with a variation example of the present embodiment.

In the description so far, the liquid crystal display device, as an example, includes four TCONs such that the display images in the four areas of the display surface are controlled individually by using these TCONs. Alternatively, there may be included less than or more than four TCONs.

Referring to FIG. 4, a liquid crystal display device 1A in accordance with the variation example includes two TCONs 21 and 22, The liquid crystal display panel 10 is divided into two areas, left and right, for which are there respectively provided TCONs 21 and 22 to control the images displayed in the areas.

A pair of gate drivers (not shown) is provided on the opposing edges of each area in the liquid crystal display device 1A as in the liquid crystal display device 1. In addition, the TCONs 21 and 22 each supply a gate-driver-driving signal GDsig to the associated pair of gate drivers. Each area is provided with a group of gate lines. Each group of gate lines is independent from the other group, such that in each area, the associated pair of gate drivers applies a voltage to the ends of each gate line.

In the liquid crystal display device 1A, the group of gate lines for each area is independent from the group for the other area, such that the gate drivers for each area can apply a voltage to the gate lines in that area based on the gate-driver-driving signal GDsig supplied from either the ICON 21 or 22 associated with the area. Each pair of gate drivers therefore applies a voltage to the ends of each gate line in the associated area at the same timing without having to synchronize the gate-driver-driving signals GDsig supplied by the TCONs 21 and 22, No excessive current hence flows through the gate lines, which enables control of display images without damaging the gate drivers and related components.

If the video signals fed from external video signal sources to the TCONs 21 and 22 are not synchronized, the liquid crystal display device 1A is still capable of displaying independent images in the areas based on those video signals because each ICON 21 and 22 supplies a gate-driver-driving signal GDsig based on its own one of the video signals.

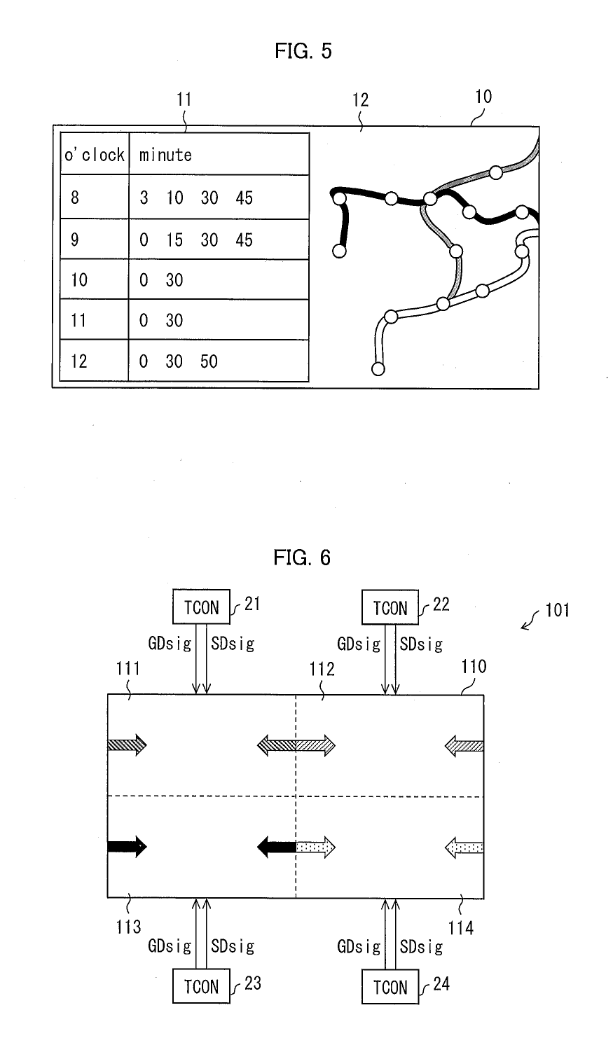

FIG. 5 is a drawing showing example images displayed on the liquid crystal display panel in the liquid crystal display device in accordance with the variation example.

As shown in FIG. 5, when a video signal A is fed to the TCON 21 to display a timetable, and a video signal B is fed to the TCON 22 to display a railway map, the liquid crystal display device 1A is capable of displaying the timetable in the first area 11 and the railway map in the second area 12 even if the video signal A and the video signal B are not synchronized.

### Embodiment 2

The following will describe another embodiment of the present invention in reference to FIGS. 6 to 8. Members of the embodiment that have the same function as members of a previous embodiment are indicated by the same reference numerals, and description thereof may be omitted for convenience of description.

### Liquid Crystal Display Device

FIG. 6 is a schematic view of a liquid crystal display device in accordance with the present embodiment.

Referring to FIG. 6, a liquid crystal display device 101 in accordance with the present embodiment includes a liquid crystal display panel 110, a backlight (not shown), gate drivers (not shown), source drivers (not shown), and four TCONs 21, 22, 23, and 24.

The liquid crystal display panel 110 is an 8 K super-high-vision liquid crystal display panel with a matrix of 7,680 pixels by 4,320 pixels (aspect ratio of 16:9).

As shown in FIG. 6, the display surface of the liquid crystal display panel 110 is horizontally and vertically bisected equally into 2×2=4 areas 111, 112, 113, and 114, The TCONs 21, 22, 23, and 24 are provided, one for each area, to control images displayed in these respective areas.

Specifically, the display surface of the liquid crystal display panel 110 is divided into the first area 111, the second area 112, the third area 113, and the fourth area 114. The TCON 21 is associated with the first area 111, the TCON 22 is associated with the second area 112, the ICON 23 is associated with the third area 113, and the TCON 24 is associated with the fourth area 114.

Each of the areas 111, 112, 113, and 114, into which the display surface is divided, is a display area with 3,840×2,160 pixels.

In the liquid crystal display device 101, the four TCONs 21, 22, 23, and 24 are used to independently control driving of the pixels in the areas 111, 112, 113, and 114. The TCONs 21, 22, 23, and 24, each capable of 4 K resolution, drive 3,840×2,160 pixels in a controlled manner at 120 Hz.

This configuration allows for an increased maximum pixel count and an increased maximum frame rate for the liquid crystal display panel 110, thereby producing a super-high-vision (7,680 pixels by 4,320 pixels, 120 Hz) image.

### Gate Drivers and Gate Lines

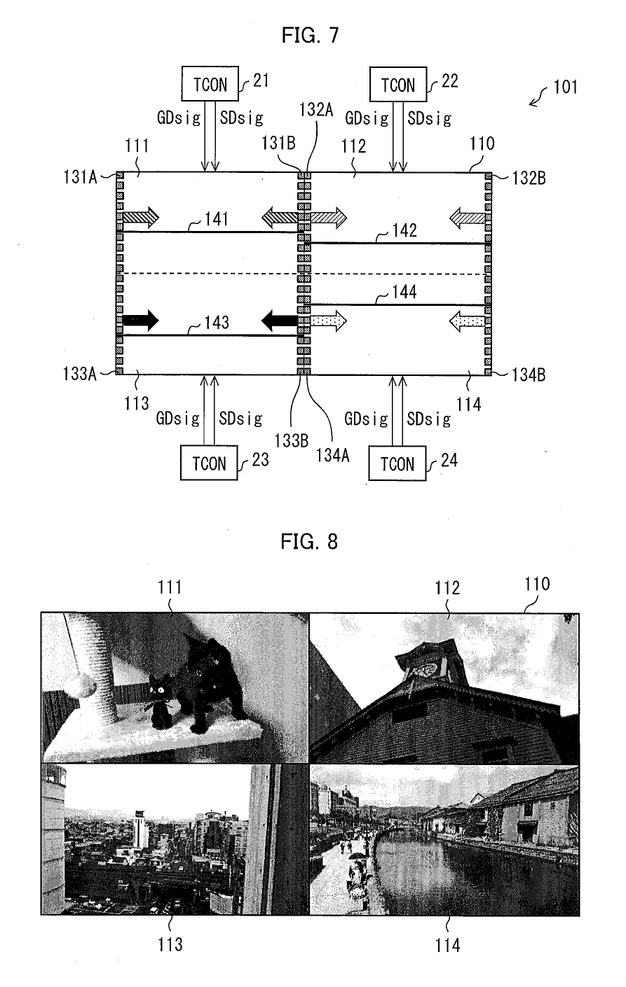

FIG. 7 is a detailed schematic view of the liquid crystal display device in accordance with the present embodiment.

As shown in FIG. 7, a pair of gate drivers is monolithically formed in each area of the liquid crystal display panel 110.

Specifically, the areas are all rectangular. A pair of gate drivers 131A and 131B is provided on the opposing shorter edges of the first area 111. A pair of gate drivers 132A and 132B is provided on the opposing shorter edges of the second area 112. A pair of gate drivers 133A and 133B is provided on the opposing shorter edges of the third area 113. A pair of gate drivers 134A and 134B is provided on the opposing shorter edges of the fourth area 114.

Therefore, the shorter edges of the first area 111 on which the gate drivers 131A and 131B are provided and the shorter edges of the third area 113 on which the gate drivers 133A and 133B are provided are located on common straight lines, and the shorter edges of the second area 112 on which the gate drivers 132A and 132B are provided and the shorter edges of the fourth area 114 on which the gate drivers 134A and 134B are provided are located on common straight lines.

The TCON 21 supplies a gate-driver-driving signal GDsig to the gate drivers 131A and 131B. The TCON 22 supplies a gate-driver-driving signal GDsig to the gate drivers 132A and 132B. The TCON 23 supplies a gate-driver-driving signal GDsig to the gate drivers 133A and 133B. The TCON 24 supplies a gate-driver-driving signal GDsig to the gate drivers 134A and 134B.

The first area 111 is provided with a group of gate lines 141. The second area 112 is provided with a group of gate lines 142. The third area 113 is provided with a group of gate lines 143. The fourth area 114 is provided with a group of gate tines 144. Each group of gate lines is provided for an associated one of the areas, independently from the other groups.

The gate drivers 131A and 131B apply a voltage to the ends of each gate line 141 in the first area 111. The gate drivers 132A and 132B apply a voltage to the ends of each gate line 142 in the second area 112. The gate drivers 133A and 133B apply a voltage to the ends of each gate line 143 in the third area 113. The gate drivers 134A and 134B apply a voltage to the ends of each gate line 144 in the fourth area 114.

This configuration enables individual control of the images displayed in the areas based on video signals fed to the TCONs 21, 22, 23, and 24, thereby producing an 8 K super-high-vision or like high-definition image on the liquid crystal display panel 110.

The TCONs control the images displayed in the areas individually. The group of gate lines for each area is independent from those groups for the other areas, such that the gate drivers for each area can apply a voltage to the gate lines in that area based on the gate-driver-driving signal GDsig supplied from the TCON associated with the area, Each pair of gate drivers therefore applies a voltage to the ends of each gate line in the associated area at the same timing without having to synchronize the gate-driver-driving signals GDsig supplied by the TCONs 21, 22, 23, and 24. No excessive current hence flows through the gate lines, which enables control of display images without damaging the gate drivers and related components.

If the video signals fed from external video signal sources to the TCONs 21, 22, and 24 are not synchronized, images can still be individually displayed in the areas based on those video signals because each TCON 21, 22, 23, and 24 supplies a gate-driver-driving signal GDsig based on its own one of the video signals.

FIG. 8 is a drawing showing example images displayed on a liquid crystal display panel in the liquid crystal display device in accordance with the present embodiment.

As shown in FIG. 8, when video signals A to D are fed respectively to the TCONs 21, 22, 23, and 24, the liquid crystal display device 101 is capable of displaying an image represented by the video signal A in the first area 111, an image represented by the video signal B in the second area 112, an image represented by the video signal C in the third area 113, and an image represented by the video signal in the fourth area 114 even if the video signals A to D are not synchronized.

Additionally, in the liquid crystal display device 101 in accordance with the present embodiment, the shorter edges of the first area 111 (one area) on which the gate drivers 131A and 131B are provided and the shorter edges of the third area 113 (another area) on which the gate drivers 133A and 133B are provided are located on common straight lines, and the shorter edges of the second area 112 on which the gate drivers 132A and 132B are provided and the shorter edges of the fourth area 114 on which the gate drivers 134A and 134B are provided are located on common straight lines.

Therefore, by concurrently driving the gate drivers 131A, 131B, 132A, and 132B and concurrently driving the gate drivers 133A, 133B, 134A, and 134B, the time taken for all the pixels in the liquid crystal display panel 110 to be charged can be halved, or the charging period for each pixel can be doubled, when compared with the configuration in which a pair of gate drivers is provided on the longer edges of each rectangular area.

### Embodiment 3

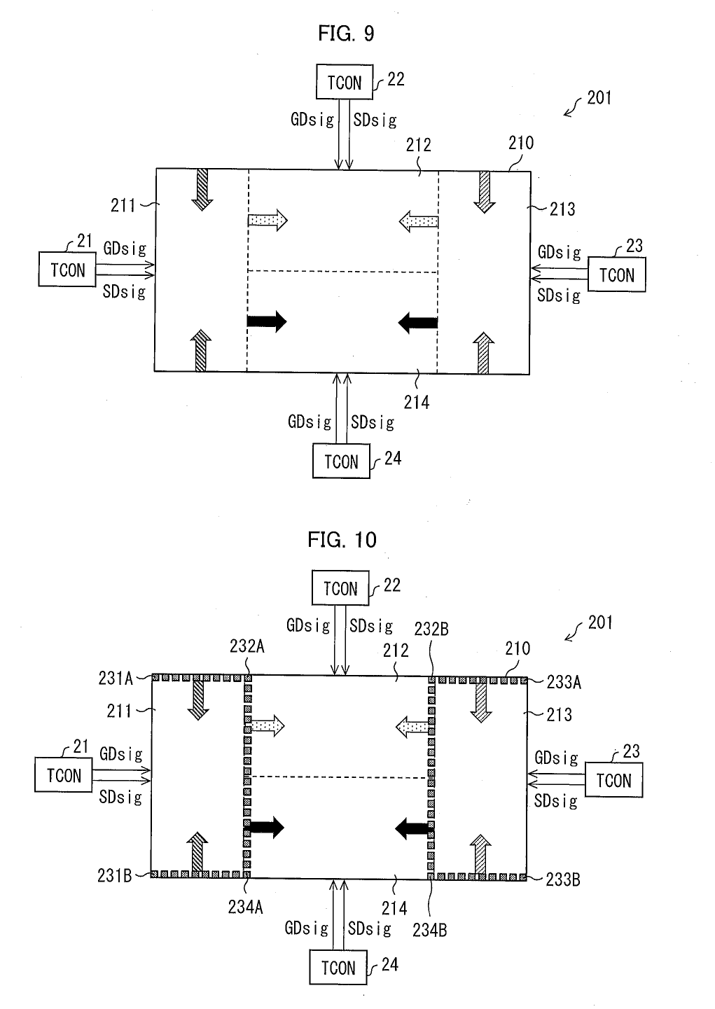

The following will describe another embodiment of the present invention in reference to FIGS. 9 to 11. Members of the embodiment that have the same function as members of a previous embodiment are indicated by the same reference numerals, and description thereof may be omitted for convenience of description.

### Liquid Crystal Display Device

FIG. 9 is a schematic view of a liquid crystal display device in accordance with the present embodiment.

Referring to FIG. 9, a liquid crystal display device 201 in accordance with the present embodiment includes a liquid crystal display panel 210, a backlight (not shown), gate drivers (not shown), source drivers (not shown), and four TCONs 21, 22, 23, and 24.

The liquid crystal display panel 210 is an 8 K super-high-vision liquid crystal display panel with a matrix of 7,680 pixels by 4,320 pixels (aspect ratio of 16:9).

As shown in FIG. 9, the display surface of the liquid crystal display panel 210 is rectangular and divided into four areas 211, 212, 213, and 214 such that each area has a longer edge that lies on a different one of the edges of the display surface. The TCONs 21, 22, 23, and 24 are provided, one for each area, to control images displayed in these areas.

Specifically, the display surface of the liquid crystal display panel 210 is divided into the first area 211, the second area 212, the third area 213, and the fourth area 214. The first area 211 has a longer edge forming one of shorter edges of the display surface, and the third area 213 has a longer edge forming the other shorter edge of the display surface. The second area 212 has a longer edge forming, in combination with one of shorter edges of the first area 211 and one of shorter edges of the third area 213, one of longer edges of the display surface, and the fourth area 214 has a longer edge forming, in combination with the other shorter edge of the first area 211 and the other shorter edge of the third area 213, the other longer edge of the display surface. In other words, each edge of the display surface contains a longer edge of a different one of the areas.

The TCON 21 is associated with the first area 211, the TCON 22 is associated with the second area 212, the TCON 23 is associated with the third area 213, and the TCON 24 is associated with the fourth area 214.

The first area 211 and the third area 213 provide a display area with 1,920×4,320 pixels. The second area 212 and the fourth area 214 provide a display area with 3,840×2,160 pixels. In the liquid crystal display device 201 in accordance with the present embodiment, the first area 211 and the third area 213 each have a different size of pixel matrix than, but have the same pixel count as, the second area 212 and the fourth area 214. Therefore, the control signals, including the clock signals supplied from the TCONs, may be the same for all the areas 211, 212, 213, and 214.

In the liquid crystal display device 201, the four TCONs 21, 22, 23, and 24 are used. to independently control driving of the pixels in the areas 211, 212, 213, and 214. The TCONs 21, 22, 23, and 24 are all capable of 4 K resolution. The TCONs 21 and 23 drive 1,920×4,320 pixels in a controlled manner at 120 Hz, whereas the TCONs 22 and 24 drive 3,840×2,160 pixels in a controlled manner at 120 Hz.

This configuration allows for an increased maximum pixel count and an increased maximum frame rate for the liquid crystal display panel 210, thereby producing a super-high-vision (7,680 pixels by 4,320 pixels, 120 Hz) image.

Gate Drivers and Gate Lines

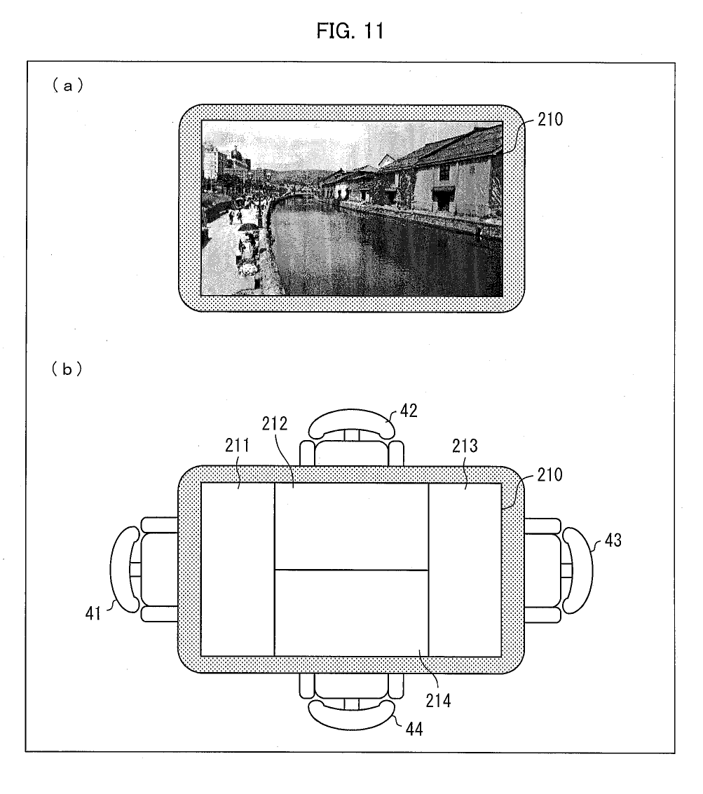

FIG. 10 is a detailed schematic view of the liquid crystal display device in accordance with the present embodiment.

As shown in FIG. 10, a pair of gate drivers is monolithically formed in each area of the liquid crystal display panel 210.

Specifically, the areas are all rectangular. A pair of gate drivers 231A and 231B is provided on the opposing shorter edges of the first area 211. A pair of gate drivers 232A and 232B is provided on the opposing shorter edges of the second area 212. A pair of gate drivers 233A and 233B is provided on the opposing shorter edges of the third area 213. A pair of gate drivers 234A and 234B is provided on the opposing shorter edges of the fourth area 214.

Therefore, the shorter edges of the second area 212 on which the gate drivers 232A and 232B are provided and the shorter edges of the fourth area 214 on which the gate drivers 234A and 234B are provided are contained in common straight lines.

The TCON 21 supplies a gate-driver-driving signal GDsig to the gate drivers 231A and 231B. The ICON 22 supplies a gate-driver-driving signal GDsig to the gate drivers 232A and 232B. The TCON 23 supplies a gate-driver-driving signal GDsig to the gate drivers 233A and 233B. The TCON 24 supplies a gate-driver-driving signal GDsig to the gate drivers 234A and 234B.

The first area 211 is provided with a group of gate lines. The second area 212 is provided with a group of gate lines. The third area 213 is provided with a group of gate lines. The fourth area 214 is provided with a group of gate lines. Each group of gate lines is provided for an associated one of the areas, independently from the other groups.

The gate drivers 231A and 231B apply a voltage to the ends of each gate line in the first area 211. The gate drivers 232A and 232B apply a voltage to the ends of each gate line in the second area 212. The gate drivers 233A and 233B apply a voltage to the ends of each gate line in the third area 213. The gate drivers 234A and 234B apply a voltage to the ends of each gate line in the fourth area 214.

This configuration enables individual control of the images displayed in the areas based on video signals fed to the TCONs 21, 22, 23, and 24, thereby producing an 8 K super-high-vision or like high-definition image on the liquid crystal display panel 210.

The TCONs control the images displayed in the areas individually. The group of gate lines for each area is independent from those groups for the other areas, such that the gate drivers for each area can apply a voltage to the gate lines in that area based on the gate-driver-driving signal GDsig supplied from the TCON associated with the area. Each pair of gate drivers therefore applies a voltage to the ends of each gate line in the associated area at the same timing without having to synchronize the gate-driver-driving signals GDsig supplied by the TCONs 21, 22, 23, and 24, No excessive current hence flows through the gate lines, Which enables control of display images without damaging the gate drivers and related components,

If the video signals fed from external video signal sources to the TCONs 21, 22, 23, and 24 are not synchronized, images can still be individually displayed in the areas based on those video signals because each TCON 21, 22, 23, and 24 supplies a gate-driver-driving signal GDsig based on its own one of the video signals.

Portion (a) FIG. 11 is a drawing showing an example image displayed on the liquid crystal display panel in the liquid crystal display device in accordance with the present embodiment, and portion (b) of FIG. 11 is a drawing showing another example use of the liquid crystal display panel in the liquid crystal display device in accordance with the present embodiment.

As shown in (a) of FIG. 11, when a single 8 K-resolution video signal is fed to the TCONs 21, 22, 23, and 24, the liquid crystal display device 201 displays an image across the entire display surface based on that video signal, by the TCONs 21, 22, 23, and 24 each supplying a gate-driver-driving signal GDsig based on the single video signal. In such a case, because the data on the gate-driver-driving signal GDsig and the source-driver-driving signal SDsig needs to be re-ordered in a signal processing circuit, there is a need for frame memory.

As shown in (b) of FIG. 11, when video signals A to D are fed respectively to the TCONs 21, 22, 23, and 24, the liquid crystal display device 201 is capable of displaying an image represented by the video signal A in the first area 211, an image represented by the video signal B in the second area 212, an image represented by the video signal C in the third area 213, and an image represented by the video signal D in the fourth area 214 even if the video signals A to D are not synchronized.

Additionally, in the liquid crystal display device 201, each edge of the display surface of the liquid crystal display panel 210 contains a longer edge of a different one of the areas. Therefore, as shown in (b) of FIG. 11, if the liquid crystal display panel 210 is built into a rectangular table, identical images may be individually displayed in the areas for viewing by the viewers sitting on chairs 41, 42, 43, and 44 positioned facing the edges of the table.

In this configuration, for example, a single image may be displayed using the entire screen in a presentation session as shown in (a) of FIG. 11, whereas in a meeting, identical images may be individually displayed in the areas to show graphical reference material to attendees of the meeting as shown in (b) of FIG. 11.

### Variation Examples

Embodiments 1 to 3 describe, as an example, a liquid crystal display device in which a pair of gate drivers is provided on the opposing edges of each area of the liquid crystal display panel to apply a voltage to the ends of each gate line that area. The present invention is however by no means limited to this configuration.

In each of the embodiments, the gate drivers may be separately disposed in any suitable locations in the associated area, and each gate driver may be configured to apply a voltage to a single end of each gate line in the associated area.

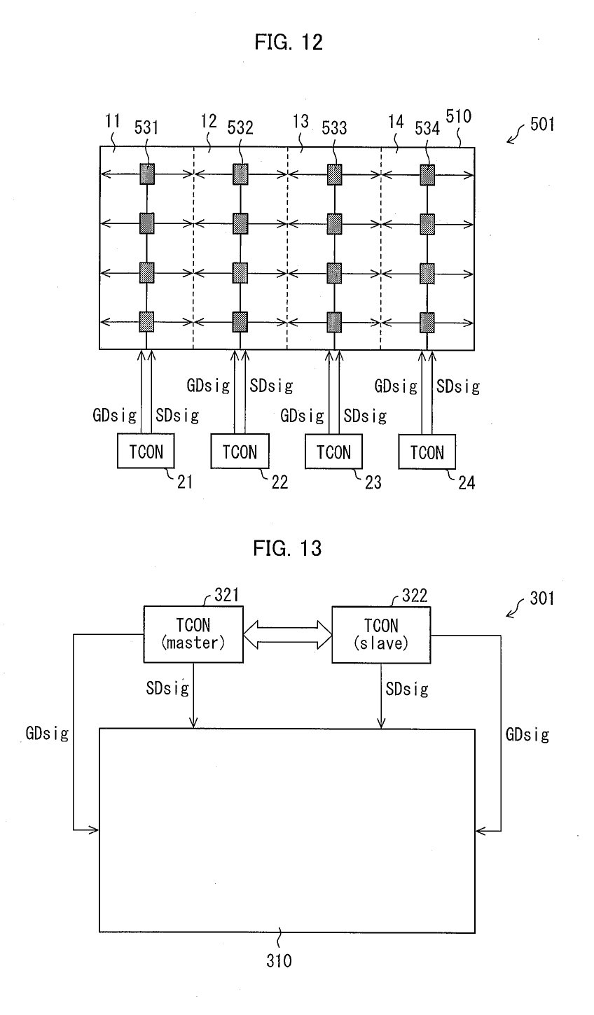

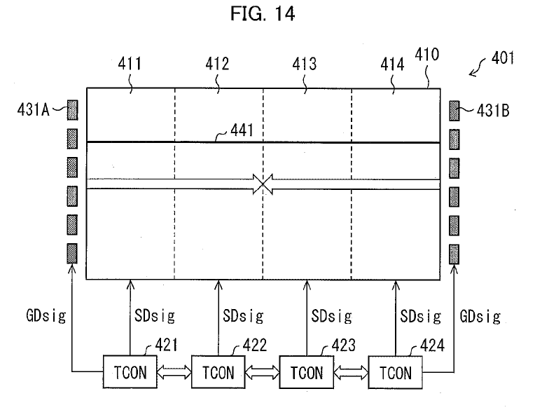

FIG. 12 is a detailed schematic view of a liquid crystal display device in accordance with a variation example.

As shown in FIG. 12, a liquid crystal display device 501 includes a gate driver 531 in a first area 11 of a liquid crystal display panel 510, a gate driver 532 in a second area 12, a gate driver 533 in a third area, and a gate driver 534 in a fourth area 14.

The gate driver 531 applies a voltage to an end of each gate line in the first area 11. The gate driver 532 applies a voltage to an end of each gate line in the second area 12. The gate driver 533 applies a voltage to an end of each gate line in the third area 13. The gate driver 534 applies a voltage to an end of each gate line in the fourth area 14.

This configuration enables individual control of the images displayed in the areas based on video signals fed from the TCONs 21, 22, 23, and 24 as in the case with the liquid crystal display device of each embodiment 1 to 3, thereby producing an 8 K super-high-vision or like high-definition image on the liquid crystal display panel 510.

### Overview

The present invention, in aspect 1 thereof, is directed to a display device (liquid crystal display device 1, 101, or 201) including: a display panel (liquid crystal display panel 10, 110, or 210) including an array of pixels; and a plurality of control units (TCONs 21 to 24), one for each one of areas (first to fourth areas 11 to 14) of a display surface of the display panel, configured to control images displayed in the areas, wherein the display panel includes: gate lines (41 to 44) provided independently for each area; and gate drivers (31A to 34A and 31B to 34B) provided independently for each area and applying a voltage to the gate lines to sequentially scan the pixels, and each control unit supplies a drive signal to drive an associated one(s) of the gate drivers based on an externally supplied video signal.

In this configuration, a plurality of control units is provided for each area. High-definition images can hence be controlled that are displayed on a high-definition display panel.

In addition, the gate lines are provided independently for each area, and each area is provided with a pair of gate drivers, Each control unit supplies a drive signal to drive a pair of gate drivers, Each pair of gate drivers therefore applies a voltage to the ends of each gate line in the associated area at the same timing without having to synchronize the drive signals supplied by the control units. No current hence flows through the gate lines, which enables control of display images without damaging the gate drivers and related components.

In aspect 2 of the present invention, the display device of aspect 1 may be configured to display, in each area, an image represented by one of unsynchronized video signals fed to the control units based on that one of the video signals.

In this configuration, an image can be displayed in each area independently from the other areas based on one of the video signals fed from the external video signal sources.

In aspect 3 of the present invention, the display device of aspect 1 or 2 may be configured such that: the areas are rectangular; the gate drivers for each area are provided on a pair of opposing edges of that area; and the edges of one of the areas on which the associated gate drivers are provided and the edges of another one of the areas on Which the associated gate drivers are provided are located on common straight lines.

In this configuration, by concurrently driving a pair of gate drivers in one area and pair of gate drivers in another area, the pixels in the two areas are sequentially scanned concurrently.

Hence, the time taken for all the pixels in the display panel to be charged can be reduced.

In aspect 4 of the present invention, the display device of aspect 3 may be configured such that the areas include four equal areas arranged in 2 rows and 2 columns into which the rectangular display surface is divided.

In this configuration, the time taken for all the pixels in the display panel to be charged can be halved, or the charging period tor each pixel can be doubled, when compared with the configuration in which a pair of gate drivers is provided on the longer edges of each rectangular area.

In aspect 5 of the present invention, the display device of aspect 3 may be configured such that: the display surface is rectangular and includes the four areas; and the display surface has each edge thereof containing a longer edge of a different one of the areas.

In this configuration, images may be individually displayed for the viewers positioned facing the edges of the display surface.

In aspect 6 of the present invention, the display device of any one of aspects 1 to 5 may be configured such that the gate drivers are provided monolithically with the display panel.

In this configuration, there is no need to mount the gate drivers to the display panel, which reduces manufacturing costs.

The present invention, in aspect 7 thereof, is directed to a method of controlling an image on a display device including: a display panel including an array of pixels; and gate lines provided independently for each one of areas of a display surface of the display panel, the method including the step of applying a voltage to the gate lines separately for each area based on an externally supplied video signal.

The present invention is not limited to the description of the embodiments above, but may be altered within the scope of the claims. An embodiment based on a proper combination of technical means disclosed in different embodiments is encompassed in the technical scope of the present invention. Furthermore, a new technological feature may be created by combining different technological means disclosed in the embodiments.

### INDUSTRIAL APPLICABILITY

The present invention is applicable to liquid crystal display devices and other similar display devices.

### REFERENCE SIGNS LIST

1, 1A, 101, 201, 501 Liquid Crystal Display Device (Display Device
10, 110, 210, 510 Liquid Crystal Display Panel (Display Panel)
11, 111, 211 First Area (Area)
12, 112, 212 Second Area (Area)
13, 113, 213 Third Area (Area)
14, 114, 214 Fourth Area (Area)
21, 23, 24 TCON (Control Unit)
31A, 31B, 131A, 131B, 231A, 231B, 531 Gate Driver
32A, 32B, 132A, 132B, 232A, 232B, 532 Gate Driver
33A, 33B, 133A, 133B, 233A, 233B, 533 Gate Driver
34A, 34B, 134A, 134B, 234A, 234B, 534 Gate Driver

1. A display device comprising:
a display panel including an array of pixels; and
a plurality of control units, one for each one of areas of a display surface of the display panel, configured to control images displayed in the areas,
wherein
the display panel comprises: gate lines provided independently for each area; and gate drivers provided independently for each area and applying a voltage to the gate lines to sequentially scan the pixels, and
each control unit supplies a drive signal to drive an associated one(s) of the gate drivers based on an externally supplied video signal.

2. The display device according to claim 1, displaying, in each area, an image represented by one of unsynchronized video signals fed to the control units based on that one of the video signals.

3. The display device according to claim 1, wherein:
the areas are rectangular;
the gate drivers for each area are provided on a pair of opposing edges of that area; and
the edges of one of the areas on which the associated gate drivers are provided and the edges of another one of the areas on which the associated gate drivers are provided are located on common straight lines.

4. The display device according to claim 3, wherein the areas comprise four equal areas arranged in 2 rows and 2 columns into which the rectangular display surface is divided.

5. The display device according to claim 3, wherein:
the display surface is rectangular and includes the four areas; and
the display surface has each edge thereof containing a longer edge of a different one of the areas.

6. The display device according to claim 1, wherein the gate drivers are provided monolithically with the display panel.

7. A method of controlling an image on a display device including: a display panel including an array of pixels; and gate lines provided independently for each one of areas of a display surface of the display panel, the method comprising the step of applying a voltage to the gate lines separately for each area based on an externally supplied video signal.
